(19) United States
(12) Patent Application Publication
(10) Pub. No.: US 2003/0016700 A1
(43) Pub. Date: Jan. 23, 2003

(54) Reducing the impact of data packet loss

(76) Inventor: Sheng Li, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/909,542

(22) Filed: Jul. 19, 2001

(51) Int. Cl. H04J 3/18

(52) U.S. Cl. 370/477; 370/463

(57) ABSTRACT

A method for distributing frames among data packets is disclosed. A plurality of consecutive data frames is assigned to different data packets. Each data packet includes data frames that are sufficiently far apart such that the loss of any particular data packet distributes impact that the loss has on the quality of recovered data.

### BACKGROUND

The present invention relates to data packets in a packet-switched network, and more particularly, to reducing the impact of loss of such data packets in the quality of recovered data.

In a packet-switched network, data to be sent may be divided into blocks, or data packets, of fixed or variable length. Moreover, in case of multimedia data, each packet may include multiple segments or frames, where each frame represents a portion of a video frame, a graphical image, or an audio sequence. The packets are then sent individually over the network through multiple locations and then reassembled at a final location before being delivered to a user at a destination node. To ensure proper transmission and re-assembly of the data packets at the destination node, various control data, such as sequence and verification information, is typically appended to each packet in the form of a packet header. At the destination node, the packets are then reassembled and transmitted to an end user in a format compatible with the user's equipment.

A variety of packet switching protocols are available, and these protocols range in degree of efficiency and reliability. The Transmission Control Protocol/Internet Protocol (TCP/IP) suite is used to manage transmission of packets throughout the Internet. Two of the protocols within the TCP/IP suite, as examples, are Transmission Control Protocol (TCP) and User Datagram Protocol (UDP). User Datagram Protocol is an unreliable connectionless protocol, which facilitates sending and receiving of packets but does not include any intelligence to establish that a packet successfully reached its destination. Thus, in an unreliable protocol such as UDP, the loss of data packets may render accurate reproduction of data difficult. Furthermore, the loss may degrade the quality of the recovered data.

### SUMMARY

In one aspect, a method for distributing frames is disclosed. A plurality of consecutive data frames is assigned to different data packets. Each data packet includes data frames that are sufficiently far apart such that the loss of any particular data packet distributes impact that the loss has on the quality of recovered data.

In another aspect, a frame distribution system is disclosed. The system includes a processor and a packetizer. The processor is configured to assign a plurality of consecutive data frames to different data packets. Each data packet includes data frames that are sufficiently far apart such that the loss of any particular data packet distributes impact that the loss has on the quality of recovered data. The packetizer packs a current frame into a data packet assigned by the processor.

### BRIEF DESCRIPTION OF THE DRAWINGS

FIG. 1 shows a traditional method of packetizing audio frames.

FIG. 2 shows a relationship between packets and frames in conventional frame packets.

FIG. 3 illustrates a frame distribution method in accordance with an embodiment of the present invention.

FIG. 4 shows an embodiment of a relationship between packets and frames using the frame distribution method of the present invention.

FIG. 5 is flowchart of the frame distribution process according to an embodiment.

FIG. 6 shows one implementation of the frame distribution system in accordance with an embodiment of the present invention.

### DETAILED DESCRIPTION

In recognition of the above-described problems with data packet loss, especially in an unreliable protocol such as User Datagram Protocol (UDP), the present invention describes embodiments for distributing the consecutive frames/segments of data into several different data packets. This allows the impact of data packet loss to be spread out so that the impact of each packet loss on the quality of the recovered data may be reduced. Consequently, for purposes of illustration and not for purposes of limitation, the exemplary embodiments of the invention are described in a manner consistent with such use, though clearly the invention is not so limited.

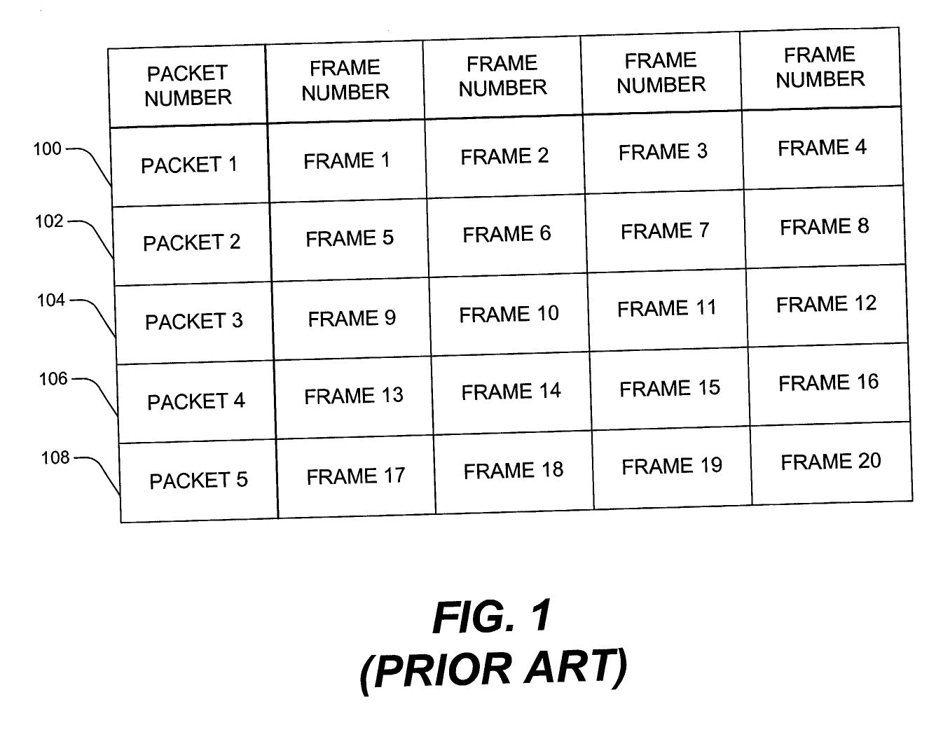

As an example, FIG. 1 shows a traditional method of packetizing audio frames. In the illustrated example, four consecutive frames of an audio sequence is packed into each data packet. Thus, packet 1 (100) includes frames 1 through 4. Further, packet 2 (102) includes frames 5 through 8; packet 3 (104) includes frames 9 through 12; packet 4 (106) includes frames 13 through 16; and packet 5 (108) includes frames 17 through 20.

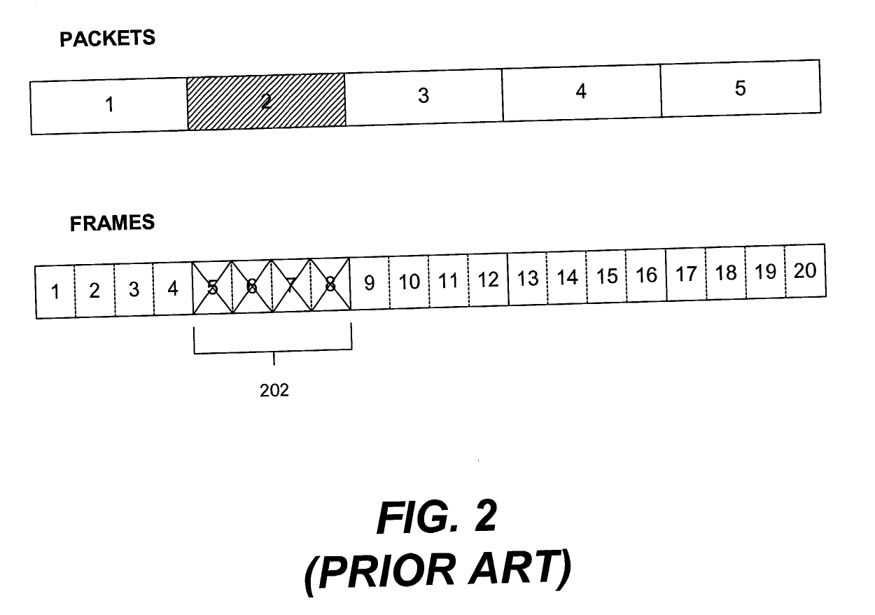

Accordingly, in this configuration, if packet 2 (102, 202) is lost, as shown in FIGS. 1 and 2, consecutive frames 5 through 8 are lost. Therefore, if these five packets 100-108 represent a single multimedia entity such as a video frame or a graphical image, a loss of one data packet introduces a loss of 20% of consecutive data within that entity. Since an unreliable protocol such as UDP uses estimation or extrapolation to reconstruct data, the 20% loss may be enough to cause significant degradation of quality in the reconstructed data. Further, if the data is time-based information, effects of the data loss may be particularly noticeable.

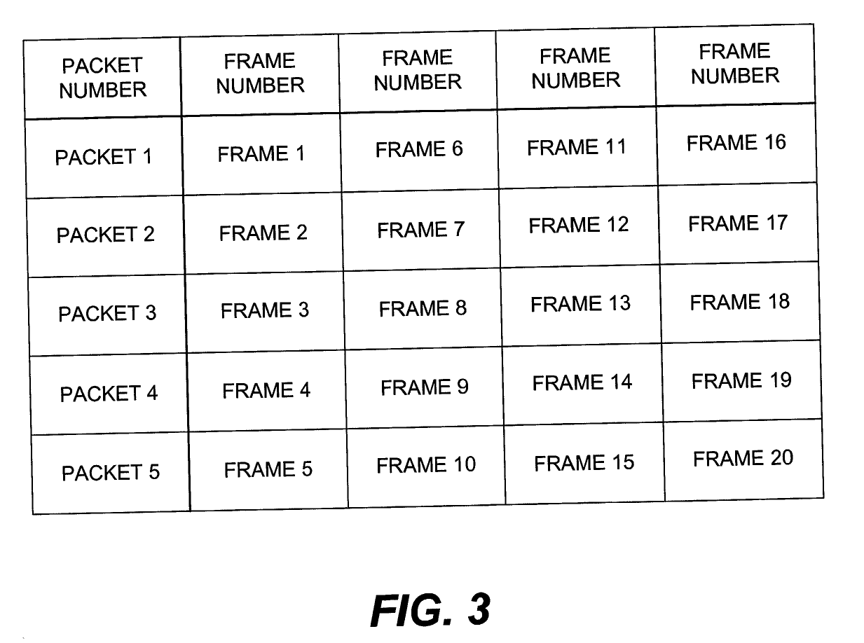

FIG. 3 shows a frame distribution method in accordance with an embodiment of the present invention, where the consecutive frames are spread out into several different packets. In the illustrated embodiment, frames 1 through 5 are spread out into packets 1 through 5, respectively. Moreover, frames 6 through 10 are packed into second positions in packets 1 through 5, respectively, and so on.

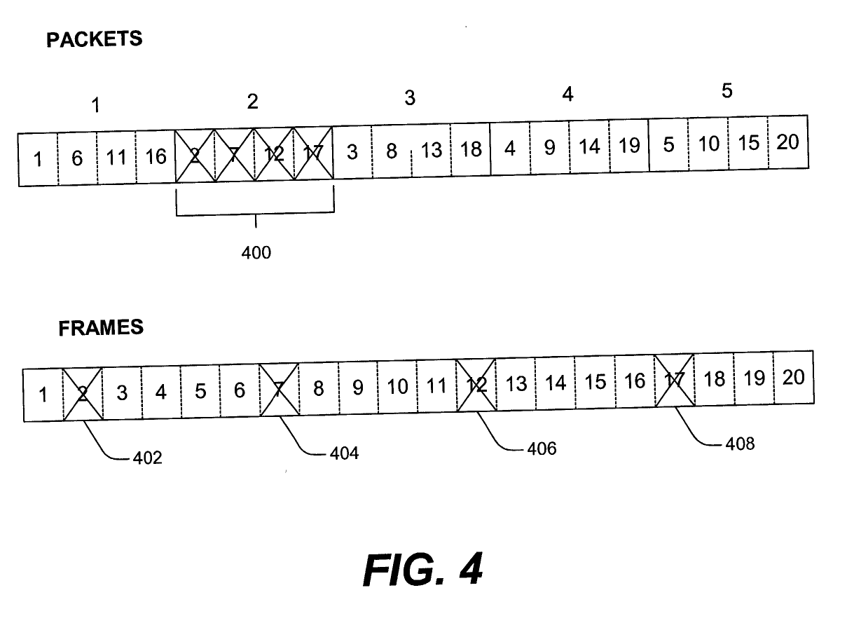

For example, if packet 2 (400) is lost in this configuration (FIGS. 3 and 4), the frames are more spread out than the conventional configuration shown in FIGS. 1 and 2. In the illustrated embodiment of FIG. 4, packet 2 (400) includes frames 2 (402), 7 (404), 12 (406), and 17 (408). Therefore, it can be seen that this configuration uniformly distributes frames. However, frames need not be distributed uniformly. The frames may be distributed in any manner that makes recovery of data more efficient than the conventional configuration. For example, multimedia frames may be distributed among different packets in a Gaussian distribution. Further, as a result of the distribution of frames among several different packets, the impact of the packet loss on the quality of the recovered data may also be distributed. Accordingly, it may be easier to extrapolate or estimate the lost frames using neighbor frames in this configuration (see FIGS. 3 and 4) than the conventional configuration (see FIGS. 1 and 2).

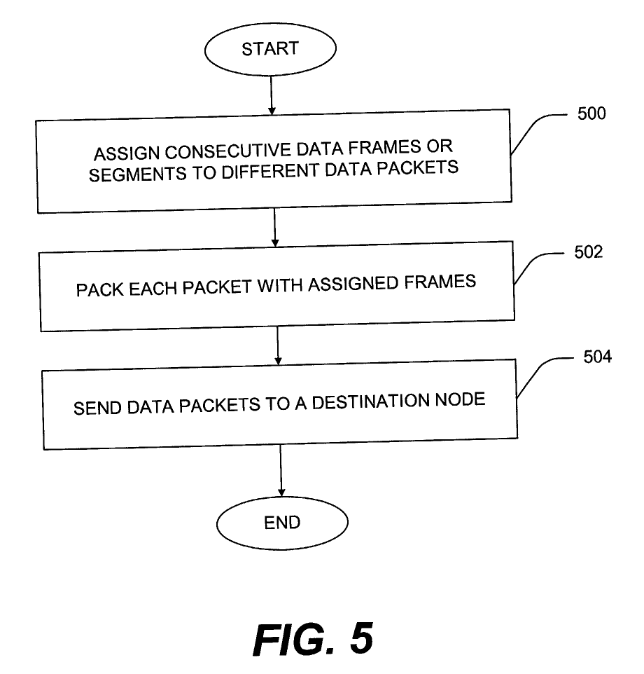

A flowchart of the frame distribution process according to an embodiment is shown in FIG. 5. The frame distribution process includes assigning consecutive data frames or segments to different data packets, at 500. In one embodiment, the distribution process may include assigning the current frame to a packet that is different from the packet that contains the previous frame. Thus, this process may be used to pack a data packet with frames that are sufficiently far apart in terms of data location within a single multimedia entity. In another embodiment, the current frame may be assigned to a packet that is different from at least some selected number of packets containing previous frames. Thus, in this embodiment, the current frame is not assigned to any of the selected number of previous packets that contain the previous frames. For example, if packet 1 includes frame 1, frame 2 may be assigned at least 2 packets away from packet 1 (e.g. at packet 3), and so on. This may prevent the loss of consecutive frames when two consecutive packets are lost. The packets are then packed with assigned frames (at 502), and sent over to a destination node (at 504).

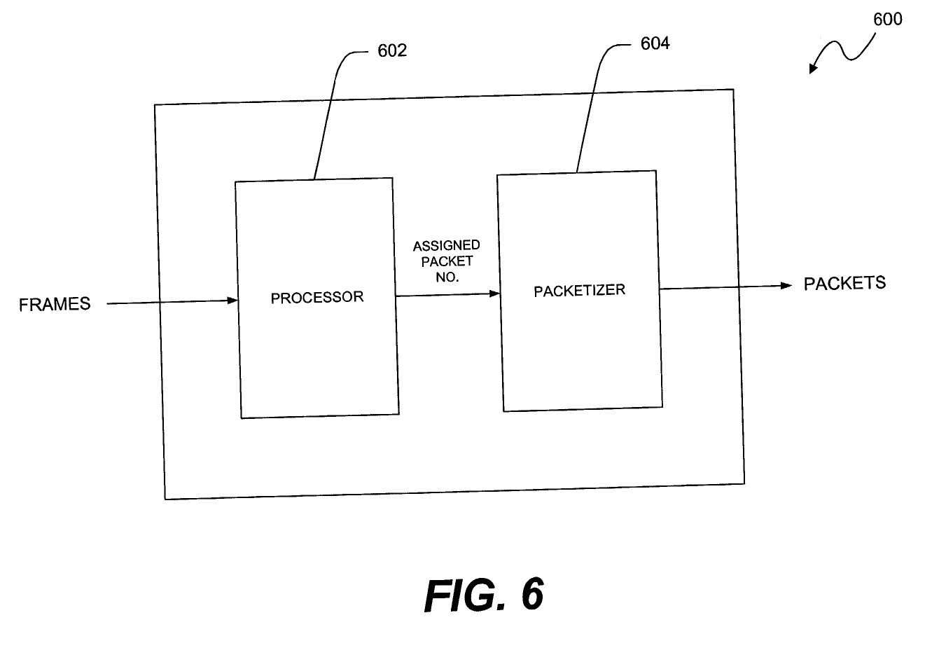

FIG. 6 shows one implementation of the frame distribution system 600 in accordance with an embodiment of the present invention. The frame distribution system 600 includes a processor 602 and a packetizer 604. The processor 602 assigns the current frame to a particular packet according to a distribution process described above, in conjunction with the flowchart of FIG. 5. The packetizer 604 packs the frame into the packet assigned by the processor 602.

There has been disclosed herein embodiments for a frame distribution process that distributes the consecutive frames into different packets so that the impact of packet loss on the quality of recovered data may be reduced. In one embodiment, the frames are uniformly distributed into different packets. The packets may be reused when the consecutive positions in the packets are assigned to frames that are sufficiently far apart. For example, packet 1 may include frame 1 in position 1, and may include frame 6 in position 2, and so on.

While specific embodiments of the invention have been illustrated and described, such descriptions have been for purposes of illustration only and not by way of limitation. Accordingly, throughout this detailed description, for the purposes of explanation, numerous specific details were set forth in order to provide a thorough understanding of the present invention. It will be apparent, however, to one skilled in the art that the system and method may be practiced without some of these specific details. For example, although the embodiments have been described with respect to audio frames, the present invention may be applicable to segments of multimedia or other related data. In other instances, well-known structures and functions were not described in elaborate detail in order to avoid obscuring the subject matter of the present invention. Accordingly, the scope and spirit of the invention should be judged in terms of the claims which follow.

What is claimed is:

1. A method for distributing frames, comprising:
assigning a plurality of consecutive data frames to different data packets, each data packet including data frames that are sufficiently far apart such that loss of any particular data packet distributes impact that the loss has on quality of recovered data.

2. The method of claim 1, further comprising:
packing said each data packet with assigned frames; and
sending the data packets to a destination node.

3. The method of claim 1, wherein said each data packet includes data frames that are at least two frames apart.

4. The method of claim 1, wherein said data frames are audio frames.

5. The method of claim 1, wherein said assigning distributes data frames into different packets at a uniform interval.

6. The method of claim 5, wherein the uniform interval is 5.

7. The method of claim 1, wherein said plurality of consecutive data frames includes at least two frames.

8. The method of claim 1, wherein said assigning a plurality of consecutive data frames includes assigning a current data frame of said plurality of consecutive data frames to a packet that is at least two packets away from a packet that contains a previous data frame.

9. A method for distributing data frames of a multimedia entity, comprising:
distributing the data frames among a plurality of data packets, each data packet including the data frames from different parts of the multimedia entity, where said data frames from different parts are sufficiently spread out among said plurality of data packets to reduce the impact of a packet loss on quality of recovered data compared to packing consecutive data frames into sequential data packets.

10. The method of claim 9, wherein said multimedia entity includes a video frame.

11. The method of claim 9, wherein said multimedia entity includes a graphical image.

12. The method of claim 9, wherein said sufficiently spreading out includes packing a data packet with data frames that are at least two frames apart.

13. The method of claim 9, wherein said plurality of data packets includes at least five packets.

14. A frame distribution system, comprising:
a processor configured to assign a plurality of consecutive data frames to different data packets, each data packet including data frames that are sufficiently far apart such that loss of any particular data packet distributes impact that the loss has on quality of recovered data; and
a packetizer to pack a current frame into a data packet assigned by said processor.

15. The system of claim 14, wherein said data frames are audio frames.

16. The system of claim 14, wherein said each data packet includes data frames that are at least two frames apart.

17. A data packetizing system, comprising:
a frame receiving element arranged to receive a sequence of data frames including consecutive parts of a segmented data entity; and
a frame assigning element arranged to assign a current data frame in said sequence of data frames to a data packet, where said frame assigning element assigns the current data frame to the data packet different from a data packet containing a previous data frame.

18. The system of claim 17, wherein said segmented data entity is a video frame.

19. The system of claim 17, wherein said segmented data entity is an audio sequence.

20. The system of claim 17, further comprising:
a frame packing element to pack data frames into assigned data packets.
